(19) United States
(12) Patent Application Publication
(10) Pub. No.: US 2026/0022591 A1
(43) Pub. Date: Jan. 22, 2026

(54) LINKING MODULE FOR ELECTRONIC LOCK

(71) Applicant: POWERTEK HARDWARE CO., LTD., TAICHUNG (TW)

(72) Inventor: Chung-Yu CHEN, TAICHUNG (TW)

(21) Appl. No.: 19/261,697

(22) Filed: Jul. 7, 2025

(30) Foreign Application Priority Data
Jul. 19, 2024 (TW) 113127226

(51) Int. Cl. E05B 63/16; E05B 47/00

(52) U.S. Cl. CPC E05B 63/16; E05B 2047/002

(57) ABSTRACT

A linking module for an electronic lock has a first rotating member and a second rotating member. Both the first rotating member and the second rotating member are connected to a linking member. The linking member is connected to a driving member. The linking member is driven by the driving member, enabling the linking member to drive the first rotating member and the second rotating member to rotate simultaneously, thereby simplifying the control structure of the electronic lock greatly.

### FIELD OF THE INVENTION

The present invention relates to a linking module applied to an electronic lock.

### BACKGROUND OF THE INVENTION

A conventional electronic lock usually has an internal control mechanism and an external control mechanism. Users inside the door can control the locking or unlocking of the electronic lock through the internal control mechanism, and users outside the door can control the locking or unlocking of the electronic lock through the external control mechanism. In other words, the conventional electronic lock needs to be equipped with two identical control devices. This is complex in structure and prone to failure.

When the conventional electronic lock is installed in a special environment, such as the vault door of a bank, users outside or inside the door need to verify their identities through an access control device before controlling the internal or external control mechanism to unlock the electronic lock for security purposes. However, this setting manner poses safety concerns because, in the event of a power outage due to an emergency such as a fire, users inside the vault may be trapped because they cannot unlock the door. If an automatic unlocking mechanism upon power outage is adopted, users outside the vault can freely enter the vault after a power outage, resulting in a loss of the anti-theft function.

### SUMMARY OF THE INVENTION

The primary object of the present invention is to provide a linking module for an electronic lock, which can drive a pair of identical structures simultaneously through a single driving member, thereby simplifying the control structure of the electronic lock greatly.

In order to achieve the foregoing object, the linking module provided by the present invention comprises a first rotating member, a second rotating member, a linking member, and a driving member. The first rotating member has a first pivoting portion and is rotatable about the first pivoting portion as its axis. The first rotating member further has a first pressing portion and a first pushed portion extending radially from a periphery of the first pivoting portion. The second rotating member has a second pivoting portion and is rotatable about the second pivoting portion as its axis. The second rotating member further has a second pressing portion and a second pushed portion extending radially from a periphery of the second pivoting portion. The linking member has a shaft portion and is rotatable about the shaft portion as its axis. The linking member further has a first pushing portion and a second pushing portion extending radially from a periphery of the shaft portion. The first pushing portion corresponds to the first pushed portion. The second pushing portion corresponds to the second pushed portion. The linking member further has a driven portion. The driving member is connected to the driven portion of the linking member. The driving member drives the driven portion to rotate the linking member. The linking member simultaneously drives the first pushed portion and the second pushed portion in a push-pull manner through the first pushing portion and the second pushing portion, enabling the first rotating member and the second rotating member to rotate simultaneously in opposite direction.

In the linking module provided by the present invention, the driving member can drive the driven portion to rotate the linking member, such that the linking member simultaneously pushes the first pushed portion and the second pushed portion through the first pushing portion and the second pushing portion, enabling the first rotating member and the second rotating member to rotate simultaneously. Thus, the linking module can simultaneously drive a pair of identical structures, such as the clutch modules of a pair of handles, through a single driving member, thereby simplifying the control structure of the electronic lock greatly.

### BRIEF DESCRIPTION OF THE DRAWINGS

FIG. 1 is a perspective view according to a preferred embodiment of the present invention;

FIG. 2 is a cross-sectional view according to the preferred embodiment of the present invention;

FIG. 3 is an exploded view of a first clutch module and a second clutch according to the preferred embodiment of the present invention;

FIG. 4 is an exploded view of a linking module according to the preferred embodiment of the present invention;

FIG. 5 is a side view of the linking module according to the preferred embodiment of the present invention;

FIG. 6 is a cross-sectional view of the linking module according to the preferred embodiment of the present invention;

FIG. 7 is a schematic view according to the preferred embodiment of the present invention when in use, wherein a linking member is in a first position;

FIG. 8 is a cross-sectional view according to the preferred embodiment of the present invention when in use, wherein the linking member is in the first position;

FIG. 9 is a schematic view according to the preferred embodiment of the present invention when in use, wherein the linking member is in a second position; and

FIG. 10 is a cross-sectional view according to the preferred embodiment of the present invention when in use, wherein the linking member is in the second position.

### DETAILED DESCRIPTION OF THE PREFERRED EMBODIMENTS

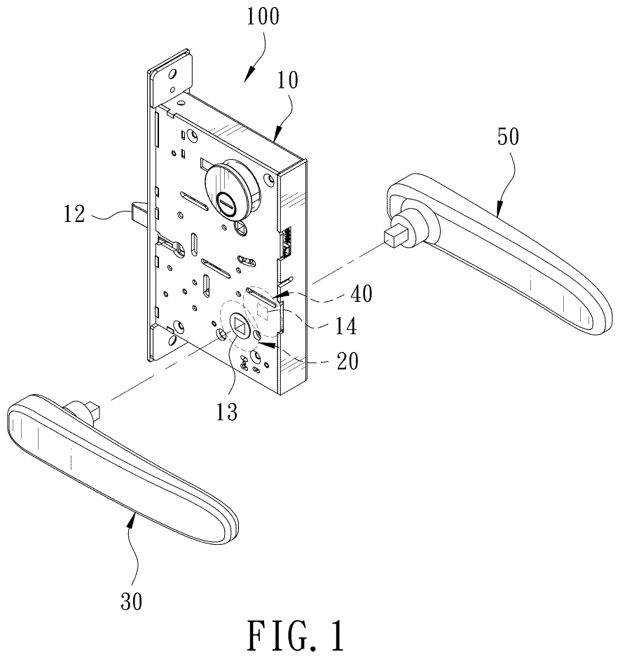

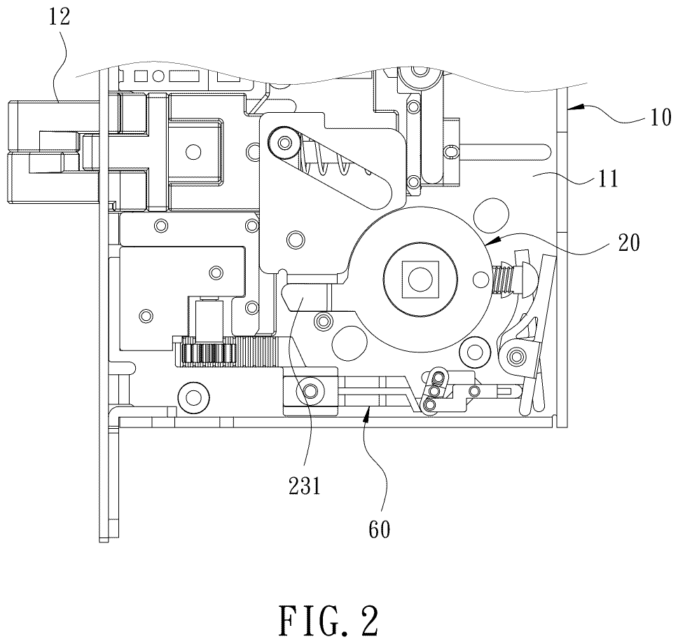

As shown in FIG. 1 and FIG. 2, the present invention discloses an electronic lock 100. The electronic lock 100 may be any type of lock. In this embodiment, the electronic lock 100 is a mortise lock as an example. The electronic lock 100 includes a main body 10. The main body 10 has an accommodation room 11 therein and a lock tongue 12 accommodated in the accommodation room 11. The lock tongue 12 is slidable relative to the main body 10 to come in or out of the main body 10. One side of the main body 10 has a first through hole 13 communicating with the accommodation room 11. A first clutch module 20 is disposed in the first through hole 13. The first clutch module 20 is connected to a first handle 30. The first handle 30 can actuate the sliding movement of the lock tongue 12 through the first clutch module 20. The other side of the main body 10 has a second through hole 14 communicating with the accommodation room 11. The second through hole 14 is coaxial with the first through hole 13. A second clutch module 40 is disposed in the second through hole 14. The second clutch module 40 is connected to a second handle 50. The second handle 50 can actuate the sliding movement of the lock tongue 12 through the second clutch module 40. The electronic lock 100 further comprises a linking module 60. The linking module 60 is disposed in the accommodation room 11 for controlling the engagement and disengagement of the first clutch module 20 and the second clutch module 40, thereby selectively allowing the first handle 30 and the second handle 50 to idle and be unable to drive the lock tongue 12. This will be described below.

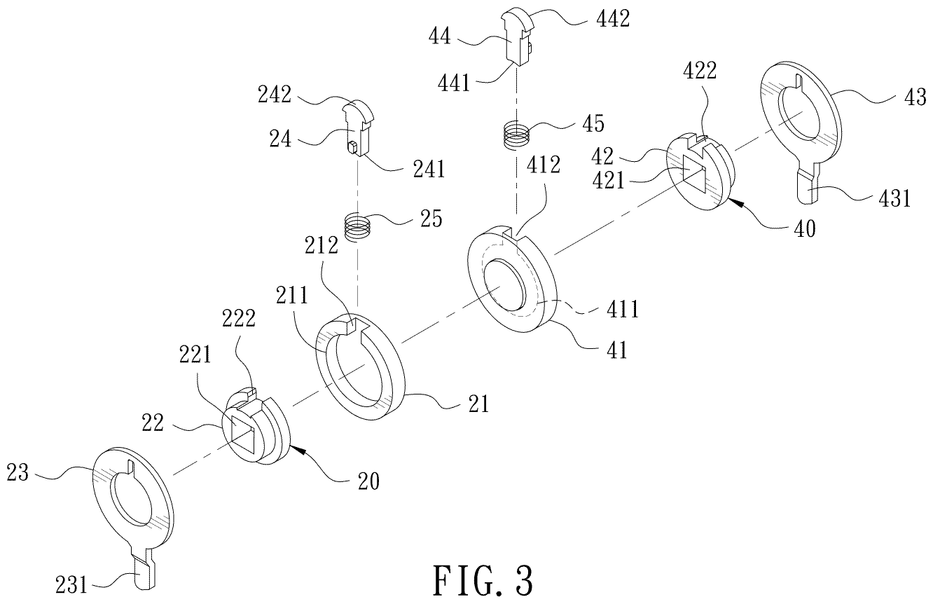

Referring to FIG. 3, the first clutch module 20 has a first outer rotating member 21. The first outer rotating member 21 has a first receiving hole 211 therein. A first inner rotating member 22 is rotatably disposed in the first receiving hole 211. The first inner rotating member 22 has a first connecting hole 221 for connecting the first handle 30 as shown in FIG. 1. The first receiving hole 211 is covered with a first outer cover 23. A first drive arm 231 extends from the first outer cover 23 for driving the lock tongue 12 to slide. The periphery of the first outer rotating member 21 has a first slide groove 212. The periphery of the first inner rotating member 22 has a first engaging groove 222 corresponding to the first slide groove 212. The first clutch module 20 further includes a slide pin 24. The first slide pin 24 is slidably disposed in the first slide groove 212. One end of the first slide pin 24, corresponding to the first engaging groove 222, has a first engaging portion 241. The other end of the first slide pin 24 extends out of the first slide groove 212 and has a first head 242. A first spring 25 is provided between the first head 242 and the first outer rotating member 21 and configured for elastically pushing the first slide pin 24 to move outward from the first slide groove 212.

Referring to FIG. 3, the second clutch module 40 is coaxially disposed on one side of the first clutch module 20. The second clutch module 40 has a second outer rotating member 41. The second outer rotating member 41 has a second receiving hole 411 therein. A second inner rotating member 42 is rotatably disposed in the second receiving hole 411. The second inner rotating member 42 has a second connecting hole 421 for connecting the second handle 50 as shown in FIG. 1. The second receiving hole 411 is covered with a second outer cover 43. A second drive arm 431 extends from the second outer cover 43 for driving the lock tongue 12 to slide. The periphery of the second outer rotating member 41 has a second slide groove 412. The periphery of the second inner rotating member 42 has a second engaging groove 422 corresponding to the second slide groove 412. The second clutch module 40 further includes a slide pin 44. The second slide pin 44 is slidably disposed in the second slide groove 412. One end of the second slide pin 44, corresponding to the second engaging groove 422, has a second engaging portion 441. The other end of the second slide pin 44 extends out of the second slide groove 412 and has a second head 442. A second spring 45 is provided between the second head 442 and the second outer rotating member 41 and configured for elastically pushing the second slide pin 44 to move outward from the second slide groove 412.

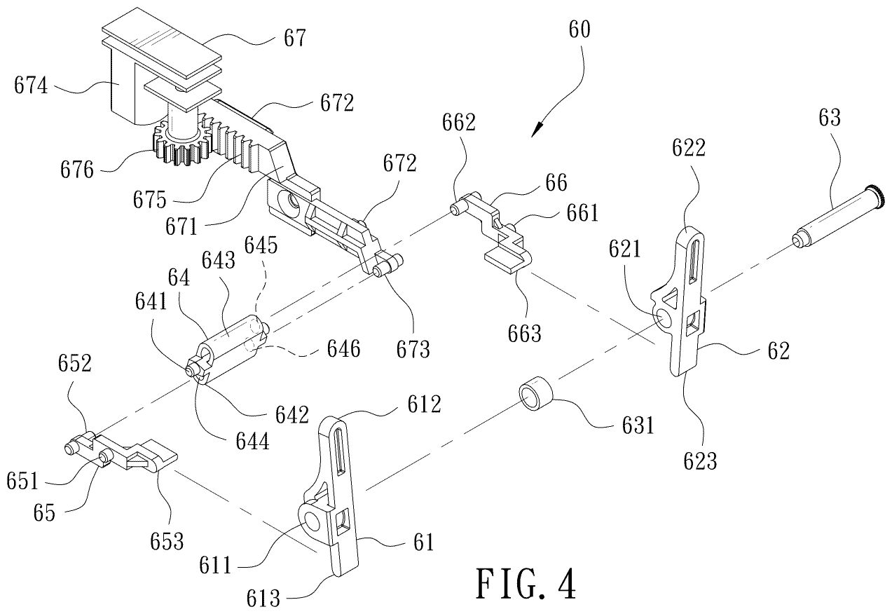

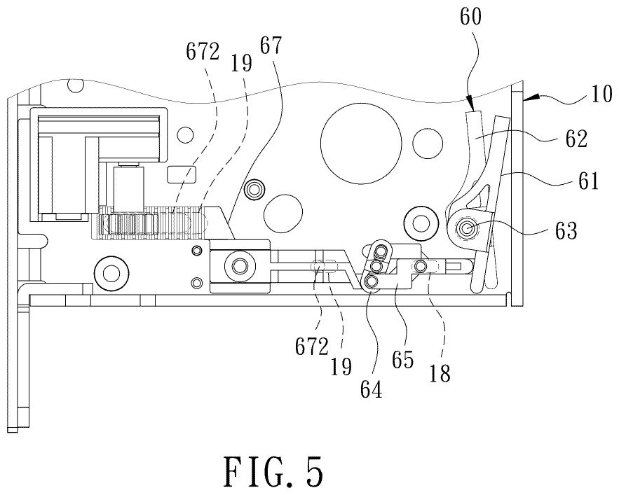

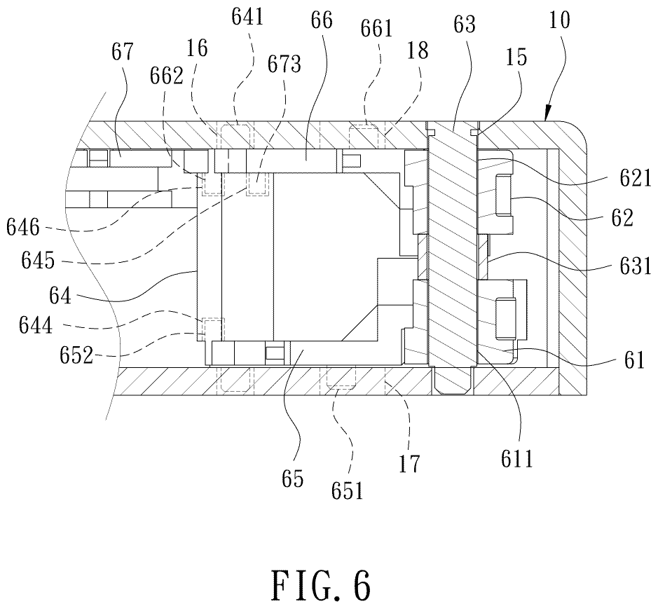

Please refer to FIG. 4, FIG. 5 and FIG. 6 again. The linking module 60 comprises a first rotating member 61. The first rotating member 61 has a first pivoting portion 611 and is rotatable about the first pivoting portion 611 as its axis. The first rotating member 61 further has a first pressing portion 612 and a first pushed portion 613 extending radially from the periphery of the first pivoting portion 611. The linking module 60 further comprises a second rotating member 62. The second rotating member 62 has a second pivoting portion 621 and is rotatable about the second pivoting portion 621 as its axis. The second rotating member 62 further has a second pressing portion 622 and a second pushed portion 623 extending radially from the periphery of the second pivoting portion 621. In this embodiment, the main body 10 has a first shaft hole 15. The first pivoting portion 611 and the second pivoting portion 621 are perforations. The linking module 60 further comprises a central shaft 63. The central shaft 63 is inserted through the first shaft hole 15, the first pivoting portion 611 and the second pivoting portion 621, allowing the first rotating member 61 and the second rotating member 62 to rotate coaxially about the central shaft 63. Preferably, a shaft sleeve 631 is fitted onto the central shaft 63. The shaft sleeve 631 is located between the first rotating member 61 and the second rotating member 62, such that the first rotating member 61 and the second rotating member 62 do not interfere with each other during rotation.

As shown in FIG. 4, FIG. 5 and FIG. 6, the linking module 60 further includes a linking member 64. The linking member 64 has a shaft portion 641 and is rotatable about the shaft portion 641 as its axis. The linking member 64 further has a first pushing portion 642 and a second pushing portion 643 extending radially from the periphery of the shaft portion 641. The first pushing portion 642 corresponds to the first pushed portion 613, and the second pushing portion 643 corresponds to the second pushed portion 623. In this embodiment, the main body 10 further has a second shaft hole 16. The shaft portion 641 is rotatably inserted into the second shaft hole 16. The first pushing portion 642 and the second pushing portion 643 of the linking member 64 extend outwardly in opposite directions by 180 degrees. Preferably, a first connecting rod 65 is provided between the first pushing portion 642 and the first pushed portion 613, and a second connecting rod 66 is provided between the second pushing portion 643 and the second pushed portion 623. The main body 10 has a first slide hole 17. The first connecting rod 65 has a first slide block 651 corresponding to the first slide hole 17. The first slide block 651 is slidably disposed in the first slide hole 17 so that the first connecting rod 65 can slide along the first slide hole 17. The first pushing portion 642 has a first elongate hole 644. One end of the first connecting rod 65 has a first protruding shaft 652. The first protruding shaft 652 is slidably disposed in the first elongate hole 644. The other end of the first connecting rod 65 is defined as a first contact end 653. The first contact end 653 is in contact with the first pushed portion 613. The main body 10 has a second slide hole 18. The second connecting rod 66 has a second slide block 661 corresponding to the second slide hole 18. The second slide block 661 is slidably disposed in the second slide hole 18 so that the second connecting rod 66 can slide along the second slide hole 18. The second pushing portion 643 has a second elongate hole 645. One end of the second connecting rod 66 has a second protruding shaft 662. The second protruding shaft 662 is slidably disposed in the second elongate hole 645. The other end of the second connecting rod 66 is defined as a second contact end 663. The second contact end 663 is in contact with the second pushed portion 623.

As shown in FIG. 4, FIG. 5 and FIG. 6, the linking member 64 further has a driven portion 646. The driven portion 646 is connected to a driving member 67. The driving member 67 drives the driven portion 646 to rotate the linking member 64. The linking member 64 simultaneously pushes the first pushed portion 613 and the second pushed portion 623 through the first pushing portion 642 and the second pushing portion 643, enabling the first rotating member 61 and the second rotating member 62 to rotate simultaneously. In this embodiment, the main body 10 has a plurality of third slide holes 19. The driving member 67 has a slide rod 671. The slide rod 671 has a plurality of third slide blocks 672. The third slide blocks 672 are slidably disposed in the respective third slide holes 19, so that the slide rod 671 can slide along the third slide holes 19. The driven portion 646 is an elongate hole. One end of the slide rod 671 has a third protruding shaft 673. The third protruding shaft 673 is slidably disposed in the driven portion 646. The other end of the slide rod 671 is connected to a motor 674. The slide rod 671 has a gear rack 675. The motor 674 has a gear 676. The gear 676 is meshed with the gear rack 675.

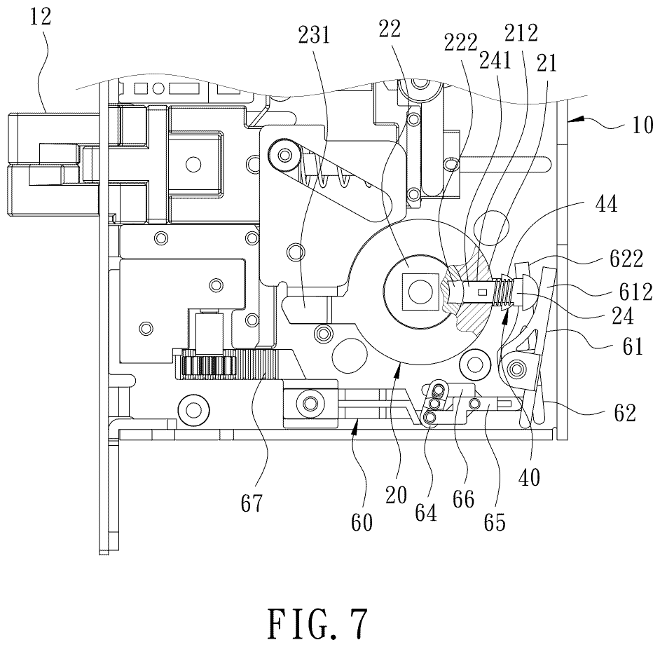

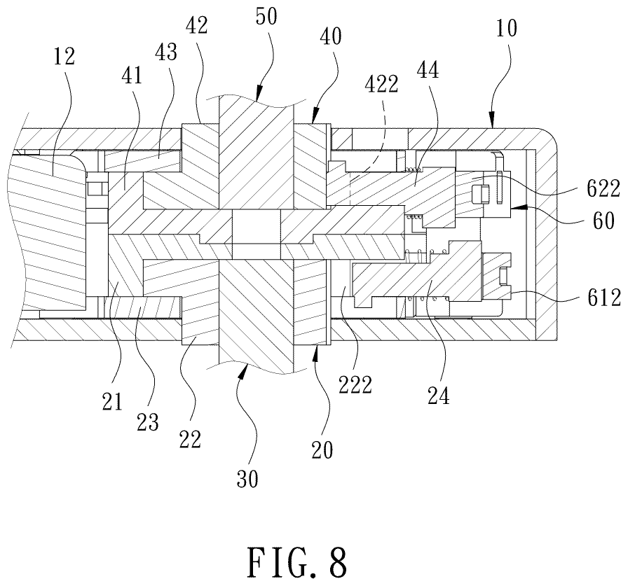

Referring to FIG. 7 and FIG. 8, the linking module 60 may be used for controlling a pair of identical devices of the electronic lock 100. In this embodiment, the linking module 60 is used for controlling the engagement and disengagement of the first clutch module 20 and the second clutch module 40, thereby providing access control for the first handle 30 and the second handle 50. The first handle 30 and the second handle 50 are set to be controlled in opposite directions. That is, only one of the handles can move the lock tongue 12, while the other handle is idle, so that the purpose of one-way access control can be achieved. Taking this as an example, the first rotating member 61 and the second rotating member 62 are disposed on one side of the first clutch module 20 and the second clutch module 40, the first pressing portion 612 presses against the first slide pin 24, and the second pressing portion 622 presses against the second slide pin 44. When the driving member 67 drives the linking member 64 to a first position as shown in FIG. 7, the linking member 64 simultaneously drives the first connecting rod 65 and the second connecting rod 66 to slide in a push-pull manner, enabling the first rotating member 61 and the second rotating member 62 to rotate in opposite directions. At this time, the first pressing portion 612 is moved away from the first slide pin 24, so that the first engaging portion 241 is disengaged from the first engaging groove 222. When the user turns the first handle 30, the first handle 30 will cause the first inner rotating member 22 to idle relative to the first outer rotating member 21 and will not be able to drive the lock tongue 12. The second pressing portion 622 pushes the second slide pin 44 to move toward the second inner rotating member 42, so that the second engaging portion 441 is engaged in the second engaging groove 422. When the user turns the second handle 50, the second handle 50 drives the second inner rotating member 42 to rotate synchronously with the second outer rotating member 41, enabling the second drive arm 431 to drive the lock tongue 12 to move.

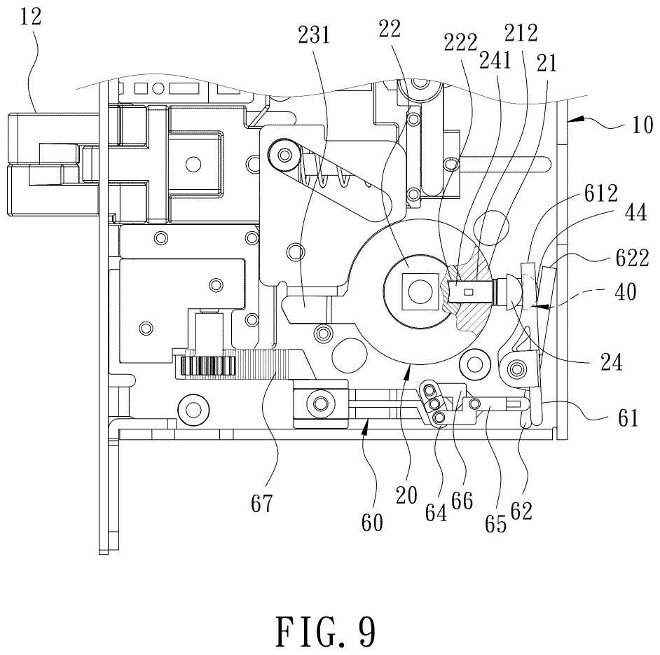

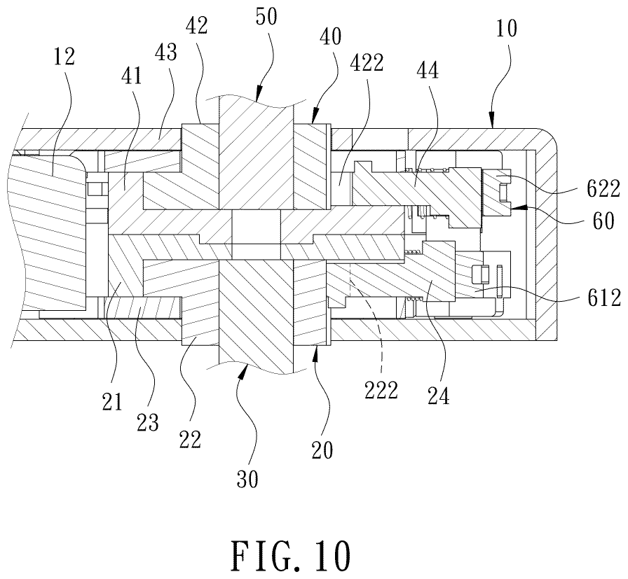

Referring to FIG. 9 and FIG. 10, when the driving member 67 reversely drives the linking member 64 to rotate to a second position as shown in FIG. 9, the linking member 64 simultaneously drives the first connecting rod 65 and the second connecting rod 66 to slide in a push-pull manner, enabling the first rotating member 61 and the second rotating member 62 to rotate in opposite directions. At this time, the first pressing portion 612 pushes the first slide pin 24 to move toward the first inner rotating member 22, so that the first engaging portion 241 is engaged in the first engaging groove 222. At the same time, the second pressing portion 622 is moved away from the second slide pin 44, enabling the second engaging portion 441 to disengage from the second engaging groove 422. Thus, the first handle 30 can drive the lock tongue 12 to move, while the second handle 50 will idle. The linking module 60 can simultaneously control the engagement and disengagement of the first clutch module 20 and the second clutch module 40 through the single driving member 67, thereby simplifying the control structure of the electronic lock 100 greatly. Because the driving member 67 controls the first rotating member 61 and the second rotating member 62 to rotate in opposite directions through the linking member 64, the first clutch module 20 and the second clutch module 40 are controlled simultaneously. This achieves the one-way access of unlocking the door from the outside and locking the door from the inside, or locking the door from the outside and unlocking the door from the inside. Normally, users inside or outside the door can unlock the door through the access control verification. In case of emergency, the door can be locked from the outside and unlocked from the inside, thereby ensuring both security and anti-theft effects. When the installation direction of the door is changed (i.e., the inside and outside are reversed), the present invention only requires changing the driving direction of the driving member 67. There is no need to disassemble the electronic lock 100 for adjustment, which makes it more convenient for users to set up the electronic lock 100.

What is claimed is:

1. A linking module for an electronic lock, comprising:
a first rotating member, having a first pivoting portion and being rotatable about the first pivoting portion as its axis, the first rotating member further having a first pressing portion and a first pushed portion extending radially from a periphery of the first pivoting portion;
a second rotating member, having a second pivoting portion and being rotatable about the second pivoting portion as its axis, the second rotating member further having a second pressing portion and a second pushed portion extending radially from a periphery of the second pivoting portion;
a linking member, having a shaft portion and being rotatable about the shaft portion as its axis, the linking member further having a first pushing portion and a second pushing portion extending radially from a periphery of the shaft portion, the first pushing portion corresponding to the first pushed portion, the second pushing portion corresponding to the second pushed portion, the linking member further having a driven portion;
a driving member, connected to the driven portion of the linking member, the driving member driving the driven portion to rotate the linking member, the linking member simultaneously driving the first pushed portion and the second pushed portion in a push-pull manner through the first pushing portion and the second pushing portion, enabling the first rotating member and the second rotating member to rotate simultaneously in opposite direction.

2. The linking module as claimed in claim 1, wherein the first pivoting portion and the second pivoting portion are perforations, the linking module further comprises a central shaft, the central shaft is inserted through the first pivoting portion and the second pivoting portion, allowing the first rotating member and the second rotating member to rotate coaxially about the central shaft.

3. The linking module as claimed in claim 2, wherein a shaft sleeve is fitted onto the central shaft, and the shaft sleeve is located between the first rotating member and the second rotating member.

4. The linking module as claimed in claim 1, wherein the first pushing portion and the second pushing portion of the linking member extend outwardly in opposite directions by 180 degrees.

5. The linking module as claimed in claim 1, further comprising a first connecting rod, the first connecting rod being connected between the first pushing portion and the first pushed portion.

6. The linking module as claimed in claim 5, wherein the first pushing portion has a first elongate hole, one end of the first connecting rod has a first protruding shaft, the first protruding shaft is slidably disposed in the first elongate hole, another end of the first connecting rod is defined as a first contact end, and the first contact end is in contact with the first pushed portion.

7. The linking module as claimed in claim 1, further comprising a second connecting rod, the second connecting rod being connected between the second pushing portion and the second pushed portion.

8. The linking module as claimed in claim 7, wherein the second pushing portion has a second elongate hole, one end of the second connecting rod has a second protruding shaft, the second protruding shaft is slidably disposed in the second elongate hole, another end of the second connecting rod is defined as a second contact end, and the second contact end is in contact with the second pushed portion.

9. The linking module as claimed in claim 1, wherein the driving member has a slide rod, one end of the slide rod is connected to the driven portion, and another end of the slide rod is connected to a motor.

10. The linking module as claimed in claim 9, wherein the slide rod has a gear rack, the motor has a gear, and the gear is meshed with the gear rack.
